(19) United States
(12) Patent Application Publication
(10) Pub. No.: US 2022/0230816 A1
(43) Pub. Date: Jul. 21, 2022

(54) ELECTROCHEMICAL DEVICE

(71) Applicant: Panasonic Intellectual Property Management Co., Ltd., Osaka (JP)

(72) Inventors: Hideki SHIMAMOTO, Kyoto (JP); Nao MATSUMURA, Osaka (JP)

(21) Appl. No.: 17/609,543

(22) PCT Filed: May 8, 2020
(86) PCT No.: PCT/JP2020/018717

§ 371 Date: Nov. 8, 2021

(30) Foreign Application Priority Data
May 9, 2019 (JP) 2019-088913

(51) Int. Cl. H01G 11/48; H01G 11/06; H01G 11/26; H01G 11/52

(52) U.S. Cl. CPC H01G 11/48; H01G 11/52; H01G 11/26; H01G 11/06

(57) ABSTRACT

An electrochemical device, including: a positive electrode including a positive electrode core material, and a positive electrode material layer supported on the positive electrode core material; a negative electrode including a negative electrode core material, and a negative electrode material layer supported on the negative electrode core material; a separator placed between the positive electrode and the negative electrode; and an electrolyte containing lithium ions. The positive electrode material layer contains a conductive polymer. The positive electrode has a positive electrode non-facing portion where the positive electrode material layer does not face the negative electrode material layer, the positive electrode non-facing portion being larger in area than a negative electrode non-facing portion where the negative electrode material layer does not face the positive electrode material layer in the negative electrode.

### TECHNICAL FIELD

The present invention relates to an electrochemical device including a positive electrode material layer containing an electrically conductive polymer.

### BACKGROUND ART

Electrochemical devices having performance intermediate between lithium ion secondary batteries and electric double-layer capacitors have been attracting attention in recent years, and the use of, for example, a conductive polymer, as a positive electrode material therefor has been examined (e.g., Patent Literature 1). An electrochemical device containing a conductive polymer as a positive electrode material is charged and discharged through adsorption (doping) and desorption (de-doping) of anions, and therefore, has small reaction resistance, and higher output than that of a typical lithium ion secondary battery.

Patent Literature 2 discloses an electric double-layer capacitor (EDLC) including an element formed by winding a positive electrode foil and a negative electrode foil with a separator interposed therebetween, and impregnated with an electrolyte. The electrolyte contains γ-butyrolactone as a solvent. The belt width of the positive electrode foil is wider than that of the negative electrode foil.

### CITATION LIST

### Patent Literature

[PTL 1] Japanese Laid-Open Patent Publication No. 2014-35836
[PTL 2] Japanese Laid-Open Patent Publication No. 2018-6717

### SUMMARY OF INVENTION

### Technical Problem

Water may be present as an impurity in the electrolyte of an electrochemical device. The water is electrically decomposed during charge, to produce H⁺ at the positive electrode and OH⁻ at the negative electrode. The produced H⁺ and OH⁻ combine with OH⁻ and H⁺ present on the counter electrode side, to produce water again. At the negative electrode, hydrogen gas may be produced together with OH⁻ in association with the electrical decomposition of water.

However, when the positive electrode has a non-facing portion not facing the negative electrode, the produced H⁺ is difficult to combine with the OH⁻ present on the counter electrode side, and tends to be localized in the vicinity of the positive electrode. As a result, the electrolyte tends to be locally acidic. On the other hand, when the negative electrode has a non-facing portion not facing the positive electrode, the produced OH⁻ is difficult to combine with the H⁺ present on the counter electrode side, and tends to be localized in the vicinity of the negative electrode. As a result, the electrolyte tends to be locally alkaline.

The separator used in an electrochemical device may be degraded by acid. Therefore, usually, in order to suppress the deterioration in performance of the separator due to the strongly acidic electrolyte, it is avoided as much as possible to provide a non-facing portion not facing the negative electrode, on the positive electrode side. For example, in Patent Literature 2, although a non-facing portion facing neither the separator nor the negative electrode is provided on the positive electrode at an end portion of the width direction of the belt being the positive electrode foil, the wound element is configured such that its outermost layer and its innermost layer are the negative electrode, thereby to avoid a portion facing the separator but not facing the negative electrode from being formed on the positive electrode (in other words, to allow a portion of the positive electrode facing the separator to face the negative electrode, too).

However, when the electrolyte of the electrochemical device contains lithium ions, the amount of hydrogen gas generated on the negative electrode side during charge tends to increase. This is presumably because, in addition to the hydrogen generation by the electrolysis of water, the lithium ions react with a component of the separator, to generate hydrogen gas. Especially when a cellulose separator is used, the reaction of the separator becomes vigorous. The amount of hydrogen gas generated remarkably increases when the electrolyte is alkaline. Furthermore, in a portion where the negative electrode does not face the positive electrode, the diffusion of lithium ions is inhibited, and due to an increase in lithium ion concentration, lithium may deposit on the surface of the negative electrode. At this time, a gas, such as carbon dioxide gas, may be generated by the reaction of the electrolyte component. Due to the gas generation as above, the internal pressure of the electrochemical device increases, which in some cases may cause cell expansion, capacity decline, rise in internal resistance, and the like.

From the viewpoint of suppressing the electrolyte from being locally strongly acidic and suppressing the deterioration in characteristics of the separator, it had better not to provide a non-facing portion not facing the negative electrode, on the positive electrode. However, when the non-facing portion is not provided on the positive electrode, the electrolyte is likely inclined to be alkaline, and the internal pressure tends to increase due to the generation of hydrogen gas. As a result, it is difficult to obtain a highly reliable electrochemical device.

### Solution to Problem

One aspect of the present disclosure relates to an electrochemical device, including: a positive electrode including a positive electrode core material, and a positive electrode material layer supported on the positive electrode core material; a negative electrode including a negative electrode core material, and a negative electrode material layer supported on the negative electrode core material; a separator placed between the positive electrode and the negative electrode; and an electrolyte containing lithium ions, wherein the positive electrode material layer contains a conductive polymer, and the positive electrode has a positive electrode non-facing portion where the positive electrode material layer does not face the negative electrode material layer, the positive electrode non-facing portion being larger in area than a negative electrode non-facing portion where the negative electrode material layer does not face the positive electrode material layer in the negative electrode.

### Advantageous Effects of Invention

According to the present disclosure, a reliable electrochemical device can be obtained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A vertical cross-sectional view of an electrochemical device according to an embodiment of the present disclosure.

FIG. 2 A schematic diagram showing a wound state of an electrode body in the electrochemical device, the electrode body being formed by stacking a positive electrode and a negative electrode with a separator interposed therebetween, and winding the stack.

FIG. 3 A graph showing evaluation results of the case swelling of electrochemical devices.

### DESCRIPTION OF EMBODIMENTS

An electrochemical device according to an embodiment of the present disclosure incudes a positive electrode including a positive electrode core material and a positive electrode material layer supported on the positive electrode core material, a negative electrode including a negative electrode core material and a negative electrode material layer supported on the negative electrode core material, a separator placed between the positive electrode and the negative electrode, and an electrolyte containing lithium ions. The negative electrode and the positive electrode, together with a separator interposing therebetween, constitute an electrode body. The electrode body is configured as, for example, a columnar wound body formed by winding a positive electrode and a negative electrode each in a belt-like shape, with a separator interposed therebetween. The electrode body may be configured as a stack formed by stacking a positive electrode and a negative electrode each in a plate-like shape, with a separator interposed therebetween.

The positive electrode has a positive electrode non-facing portion where the positive electrode material layer does not face the negative electrode material layer. The positive electrode non-facing portion is larger in area than a negative electrode non-facing portion where the negative electrode material layer does not face the positive electrode material layer in the negative electrode. The negative electrode may or may not have a negative electrode non-facing portion (i.e., the area of the negative electrode non-facing portion may be zero).

The positive electrode material layer supported on the positive electrode core material and the negative electrode material layer supported on the negative electrode core material usually face each other with the separator interposed therebetween. However, for example, when a belt-like positive electrode and a belt-like negative electrode are wound with a separator interposed therebetween to configure a wound electrode body, due to a difference in width between the belt-like positive electrode and the belt-like negative electrode, a non-facing portion not facing the positive electrode material layer or the negative electrode material layer may be formed at an end portion in the width direction of the belt. Note that, usually, the outermost layer and the innermost layer of the electrode body have the non-facing portion. Here, the positive electrode non-facing portion and the negative electrode non-facing portion do not encompass a region where the negative electrode core material without the negative electrode material layer supported thereon and the positive electrode core material without the positive electrode material layer supported thereon face each other.

When the positive electrode non-facing portion is larger in area than the negative electrode non-facing portion, the electrolyte is unlikely inclined to be alkaline. Therefore, even when the electrolyte contains lithium ions, the generation of hydrogen gas during charge can be suppressed. Thus, the increase in internal pressure of the electrochemical device can be suppressed.

As described above, when the electrolyte contains lithium ions, a large amount of hydrogen is generated at the negative electrode during charge. This is due to a reaction between the lithium ions and a component of the separator. For example, the lithium ions replace protons contained in the separator, and the protons desorb from the separator. The desorbed protons are reduced at the negative electrode, to generate hydrogen gas. Especially when the electrolyte becomes alkaline, this causes a severe deterioration in appearance of the separator, and a significant increase in the amount of hydrogen gas generated. By making the area of the positive electrode non-facing portion larger than that of the negative electrode non-facing portion, the electrolyte can be suppressed from being inclined to be alkaline, and the amount of hydrogen gas generated can be reduced.

The positive electrode material layer contains a conductive polymer. The conductive polymer has, for example, a functional group that can accept protons. When the positive electrode non-facing portion is larger in area than the negative electrode non-facing portion, the H⁺ concentration in the electrolyte tends to locally increase in the vicinity of the positive electrode non-facing portion, causing a locally acidic environment. However, the conductive polymer usually has a function to accept H⁺ and be protonated. Therefore, the increase in the H⁺ concentration in the electrolyte can be suppressed, and the electrolyte is unlikely to be strongly acidic. As a result, the deterioration in performance of the separator resulted from exposure to a strongly acidic environment can also be suppressed.

Therefore, according to the electrochemical device of the present embodiment, in the case of using an electrolyte containing lithium ions, the positive electrode non-facing portion can act to suppress the electrolyte from being inclined to be alkaline, and the conductive polymer can act to suppress the electrolyte from being inclined to be strongly acidic. That is, even after repeated charge and discharge, the electrolyte can be stably maintained, specifically, in a neutral to weak acidic state. As a result, the increase in the amount of hydrogen gas generated can be suppressed, and the deterioration in characteristics of the separator is also suppressed. Thus, a highly reliable electrochemical device can be realized.

An electrochemical device is typically configured to include an electrode body (a wound body) formed by winding a stack of the positive electrode, the negative electrode, and the separator interposing between the positive electrode and the negative electrode. In this case, in order to make the positive electrode non-facing portion larger in area than the negative electrode non-facing portion, it is effective to provide a positive electrode non-facing portion at the outermost layer of the electrode body where the facing area is large, so that the area of the positive electrode non-facing portion becomes larger than that of the negative electrode non-facing portion.

In the wound electrode body, the direction of the winding axis is defined as a width direction. The direction perpendicular to the winding axis and along the positive electrode and/or the negative electrode is defined as a longitudinal direction. The longitudinal direction is, when the positive electrode and/or the negative electrode is spread on a plane, a direction in which the positive electrode and/or the negative electrode extends like a belt

In the positive electrode, a portion located on the outermost layer side of winding is defined as a positive electrode outermost layer portion. In the negative electrode, a portion located on the outermost layer side of winding is defined as a negative electrode outermost layer portion. The area of the positive electrode non-facing portion in the positive electrode outermost layer portion may be made larger than the area of the negative electrode non-facing portion in the negative electrode outermost layer portion.

The positive electrode outermost layer portion is the last turn of winding of the positive electrode at the winding finish in the electrode body. There may be a case, however, where at an end portion in the longitudinal direction of the positive electrode, the positive electrode material layer is not formed over the entire width direction, and the positive electrode core material is exposed over the entire width direction. The positive electrode outermost layer portion is derived excluding such a region where the positive electrode core material is exposed over the entire width direction. That is, the positive electrode outermost layer portion corresponds to one turn of winding of the positive electrode that ends at the outermost layer side-boundary up to which the positive electrode material layer is formed in the longitudinal direction, in the electrode body.

Likewise, the negative electrode outermost layer portion is the last turn of winding of the negative electrode at the winding finish in the electrode body. There may be a case, however, where at an end portion in the longitudinal direction of the negative electrode, the negative electrode material layer is not formed over the entire width direction, and the negative electrode core material is exposed over the entire width direction. The negative electrode outermost layer portion is derived excluding such a region where the negative electrode core material is exposed over the entire width direction. That is, the negative electrode outermost layer portion corresponds to one turn of winding of the negative electrode that ends at the outermost layer side-boundary up to which the negative electrode material layer is formed in the longitudinal direction, in the electrode body.

Similarly, in the positive electrode, a portion located on the innermost layer side of winding is defined as a positive electrode innermost layer portion. The positive electrode innermost layer portion is the first turn of winding of the positive electrode at the winding start in the electrode body. There may be a case, however, where at an end portion in the longitudinal direction of the positive electrode, the positive electrode material layer is not formed over the entire width direction, and the positive electrode core material is exposed over the entire width direction. The positive electrode innermost layer portion is derived excluding such a region where the positive electrode core material is exposed over the entire width direction. That is, the positive electrode innermost layer portion corresponds to one turn of winding of the positive electrode from a boundary that begins at the innermost layer-side boundary from which the positive electrode material layer is formed in the longitudinal direction, in the electrode body.

Likewise, in the negative electrode, a portion located on the innermost layer side of winding is defined as a negative electrode innermost layer portion. The negative electrode innermost layer portion is the first turn of winding at the start of winding of the negative electrode in the electrode body. There may be a case, however, where at an end portion in the longitudinal direction of the negative electrode, the negative electrode material layer is not formed over the entire width direction, and the negative electrode core material is exposed over the entire width direction. The negative electrode innermost layer portion is derived excluding such a region where the negative electrode core material is exposed over the entire width direction. That is, the negative electrode innermost layer portion corresponds to one turn of winding of the negative electrode that begins at the innermost layer-side boundary from which the negative electrode material layer is formed in the longitudinal direction, in the electrode body.

The definition of the above positive electrode outermost layer portion and the above negative electrode outermost layer portion does not mean that the outermost layer of the electrode body is the positive or negative electrode. Likewise, the definition of the above positive electrode innermost layer portion and the above negative electrode innermost layer portion does not mean that the innermost layer of the electrode body is the positive or negative electrode.

When the positive electrode material layer is formed on both sides of the positive electrode core material, the area of the positive electrode outermost layer portion is derived with only one side on the radially outer side taken into consideration, and the area of the positive electrode innermost layer portion is derived with only one side on the radially inner side taken into consideration. Likewise, when the negative electrode material layer is formed on both sides of the negative electrode core material, the area of the negative electrode outermost layer portion is derived with only one side on the radially outer side taken into consideration, and the area of the negative electrode innermost layer portion is derived with only one side on the radially inner side taken into consideration.

The outermost layer of the winding in the electrode body may be the positive electrode. In this case, the entire surface of the positive electrode outermost layer portion can be a positive electrode non-facing portion. It is easy therefore to make the area of the positive electrode non-facing portion in the positive electrode outermost layer portion larger than that of the negative electrode non-facing portion in the negative electrode outermost layer portion. In this case, the separator may be present radially outside the positive electrode outermost layer portion. Here, that the outermost layer of winding is the positive electrode means that, at least part in the circumferential direction, the positive electrode outermost layer portion is located more radially outside than the negative electrode outermost layer portion, that is, in at least part in the circumferential direction, the negative electrode material layer is not present more radially outside than the positive electrode outermost layer portion, and includes a case where the separator is present radially outside the positive electrode outermost layer portion. In the whole circumference of positive electrode outermost layer portion, more than half of the circumference of the positive electrode outermost portion may not face the negative electrode material layer. In this case, the area of the positive electrode non-facing portion can be easily made larger than that of the negative electrode non-facing portion.

Similarly, the innermost layer of the winding in the electrode body may be the positive electrode. In this case, the entire surface of the positive electrode on the innermost layer can be a positive electrode non-facing portion. It is easy therefore to make the area of the positive electrode non-facing portion larger than that of the negative electrode non-facing portion. Here, that the innermost layer of winding is the positive electrode means that, at least part in the circumferential direction, the positive electrode innermost layer portion is located more radially inside than the negative electrode innermost layer portion, that is, in at least part in the circumferential direction, the negative electrode material layer is not present more radially inside than the positive electrode outermost layer portion. The separator may be present radially inside the positive electrode innermost layer portion. For example, 50% or more or 90% or more of the whole circumference of the positive electrode innermost portion may not face the negative electrode material layer.

The positive electrode non-facing portion may be present on the radially inner side from the positive electrode outermost layer portion, and may be present on the radially outer side from the positive electrode innermost layer portion.

In order to make the area of the positive electrode non-facing portion larger than that of the negative electrode non-facing portion, the size in the width direction of the positive electrode material layer supported on the positive electrode core material may be set larger than that of the negative electrode material layer supported on the negative electrode core material.

The ratio (S_{C1}−S_{A1})/S_{C0} of the difference (S_{C1}−S_{A1}) between an area S_{C1} of the positive electrode non-facing portion and an area S_{A1} of the negative electrode non-facing portion to an area S_{C0} of the positive electrode material layer supported on the positive electrode core material is, for example, 0.005 or more, and may be 0.04 or more, in view of suppressing the electrolyte from becoming alkaline. On the other hand, when the (S_{C1}−S_{A1})/S_{C0} is excessively high, it may be difficult to suppress the electrolyte from becoming strongly acidic, even though the increase in H⁺ concentration may be suppressed by the action of the conductive polymer. The (S_{C1}−S_{A1})/S_{C0} is, for example, 0.2 or less, and may be 0.12 or less, so that the conductive polymer can act to suppress the electrolyte from becoming strongly acidic. The (S_{C1}−S_{A1})/S_{C0} is, for example, 0.005 or more and 0.2 or less, and may be 0.04 or more and 0.12 or less.

The conductive polymer is preferably one that can be easily protonated. For example, in polyaniline (PANI), a proton (H+) can bond to a nitrogen atom bonded to the benzene ring. Thus, the H⁺ produced at the positive electrode during charge combines with the conductive polymer, and the increase in H⁺ concentration in the electrolyte can be suppressed. In other words, the conductive polymer can have a pH buffering function. For example, when polyaniline is used in the positive electrode, even though the H⁺ concentration in the electrolyte locally increases in the vicinity of the positive electrode non-facing portion, the electrolyte is maintained in a weakly acidic or neutral state at a pH of 2.5 or more, and the pH is unlikely to be strongly acidic (e.g., 1 or less). Therefore, the deterioration in characteristics of the separator can be suppressed.

The polyaniline refers to a polymer including aniline (C₆H₅—NH₂) as a monomer, and having an amine structural unit represented by —C₆H₄—NH—C₆H₄—NH—, and/or, an imine structural unit represented by —C₆H₄—N═C₆H₄=N—. The polyaniline that can be used as the conductive polymer, however, is not limited thereto. The polyaniline according to the present disclosure encompasses, for example, polymers in which an alkyl group, such as a methyl group, is added to part of the benzene rings, and derivatives in which a halogen group or the like is added to part of the benzene rings, as long as they are polymers whose basic skeleton is aniline.

As an index indicating the ease of protonation of the conductive polymer, for example, an acid dissociation constant pKa in water as a solvent can be used. The pKa is expressed by Equation 2 below, from a reaction equilibrium constant Ka of the reaction expressed by Reaction Formula 1 below in which PolH⁺, i.e., a protonated polymer Pol, releases proton H⁺. In the Equation 2, [X] represents a molar concentration of X.

PolH⁺+H₂O→Pol+H₃O⁺ (Reaction Formula 1)

pKa=−log₁₀ Ka

Ka=[H₃O⁺][Pol]/[PolH⁺] (Equation 2)

In an actual electrochemical device, the electrolyte contains almost no water in many cases. However, the above index pKa is useful as an index indicating the ease of protonation for conductive polymers. The pKa is in a range of 2.5 to 7. For example, the pKa of the aforementioned polyaniline can be 3.5 (average value).

As the material of the separator, for example, a cellulose material can be used. The cellulose material is generally weak against acid and discolored (carbonized) in a strongly acidic environment, and its performance as a separator tends to deteriorate. However, in the electrochemical device of the present embodiment, in which the electrolyte is unlikely to be strongly acidic, the deterioration in characteristics of the separator can be suppressed. The cellulose material can include a surface-modified cellulose synthesized by chemically modifying the hydroxyl group contained in a cellulose.

In the electrochemical device of the present embodiment, during charge, lithium ions in the electrolyte are absorbed in the negative electrode, and anions are adsorbed (doped) into the positive electrode. During discharge, the lithium ions are released from the negative electrode into the electrolyte, and the anions are desorbed (de-doped) from the positive electrode into the electrolyte. The conductive polymer performs charge and discharge through doping and de-doping of anions, and therefore, the reaction resistance is small, and a high output can be easily achieved.

### <<Electrochemical Device>>

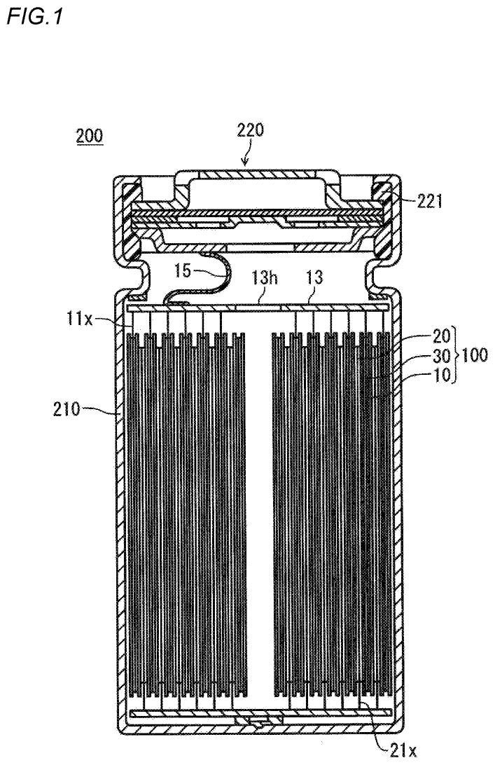

A detailed description will be given below of a configuration of an electrochemical device according to the present disclosure, with reference to the drawings. FIG. 1 schematically illustrates a configuration of an electrochemical device 200 according to an embodiment of the present disclosure.

The electrochemical device 200 includes an electrode body 100, a non-aqueous electrolyte (not shown), a bottomed metal cell case 210 containing the electrode body 100 and the non-aqueous electrolyte, and a sealing plate 220 sealing an opening of the cell case 210. A gasket 221 is disposed around the peripheral edge of the sealing plate 220. The opening end of the cell case 210 is crimped onto the gasket 221, and thus, the cell case 210 is sealed.

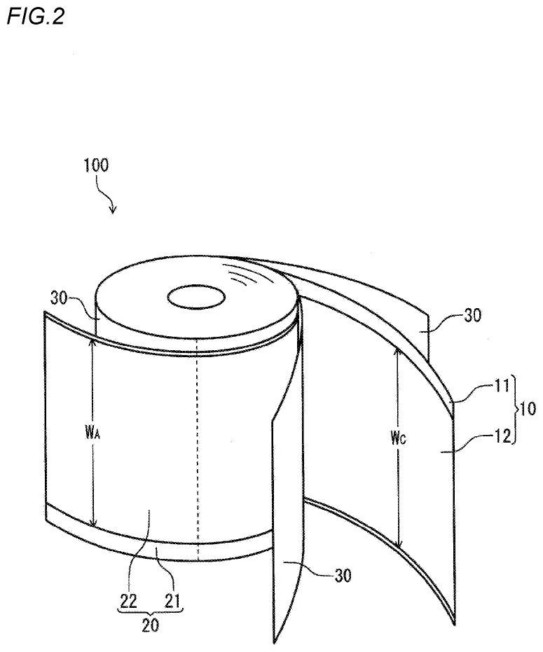

The electrode body 100 is a wound body formed by winding a positive electrode 10 and a negative electrode 20 stacked with a separator 30 interposed therebetween. FIG. 2 shows the wound state of the electrode body 100. The positive electrode 10 includes a positive electrode core material 11 and a positive electrode material layer 12 supported on the positive electrode core material 11. The negative electrode 20 includes a negative electrode core material 21 and a negative electrode material layer 22 supported on the negative electrode core material 21. The positive electrode material layer 12 and the negative electrode material layer 22 are formed on both sides of the positive electrode core material 11 and the negative electrode core material 21, respectively.

In the example illustrated in FIGS. 1 and 2, the width We of the positive electrode material layer 12 in the positive electrode 10 is larger than the width W_{A} of the negative electrode material layer 22 in the negative electrode 20. In this case, the positive electrode 10 has, at both end portions in the width direction of the positive electrode material layer 12, positive electrode non-facing portion of a belt-like shape where the positive electrode material layer 12 does not face the negative electrode material layer 22. Given that the positive electrode material layer 12 is formed on both sides of the positive electrode core material 11, the area of this positive electrode non-facing portion is approximately represented by 2(W_{C}−W_{A})L_{C}, where L_{C} is the length of the positive electrode material layer 12.

As shown in FIG. 1, the electrode body 100 may be wound such that the positive electrode 10 becomes the innermost layer and the outermost layer (except the separator 30 on the outermost layer side). In this case, the positive electrode 10 has the positive electrode non-facing portion at least on a positive electrode innermost layer portion and a positive electrode outermost layer portion of the positive electrode material layer 12. When the whole circumference of each of the positive electrode innermost layer portion and the positive electrode outermost layer portion is the positive electrode non-facing portion, the area of these positive electrode non-facing portions is approximately represented by π(R₁+R₂)W_{C}, where R₁ is the inner diameter (diameter) of the hollow portion of the electrode body 100, and R₂ is the maximum outer diameter (diameter) of the electrode body 100.

By providing a positive electrode non-facing portion as described above and thus making the area of the positive electrode non-facing portion larger than that of the negative electrode non-facing portion, the electrolyte can be suppressed from being inclined to be alkaline. In addition, by the pH buffering action of the conductive polymer, the electrolyte can also be suppressed from being inclined to be strongly acidic. As a result, in electrochemical device 200, the acidity (pH) of the electrolyte can be maintained between weakly acidic and neutral. Therefore, the deterioration in characteristics of the separator can be suppressed, and an increase in internal pressure due to an increase in hydrogen gas generation can also be suppressed. Thus, the electrochemical device 200 obtained can be highly reliable.

The positive electrode core material 11 has, in at least part of its longitudinal direction, a positive electrode core material exposed portion 11x that supports no positive electrode material layer 12 and extends in one direction in the width direction (axial direction of winding). The positive electrode core material exposed portion 11x is welded to a positive electrode current collector plate 13 having a through-hole 13h at its center. The positive electrode current collector plate 13 is connected to one end of a tab lead 15, and the other end of the tab lead 15 is connected to the inner surface of the sealing plate 220. Therefore, the sealing plate 220 has a function as an external positive electrode terminal.

On the other hand, the negative electrode core material 21 has, in at least part of its longitudinal direction, a negative electrode core material exposed portion 21x that supports no negative electrode material layer 22 and extends in one direction in the width direction (axial direction of winding). The direction in which the negative electrode core material exposed portion 21x extends is opposite to that in which the positive electrode core material exposed portion 11x extends. The negative electrode core material exposed portion 21x is welded to a negative electrode current collector plate 23. The negative electrode current collector plate 23 is directly welded to a welding member provided on the inner bottom surface of the cell case 210. Therefore, the cell case 210 has a function as an external negative electrode terminal.

In the example illustrated in FIG. 1, in order to electrically insulate the positive electrode 10 from the cell case 210, the outer side of the positive electrode outermost layer of the electrode body 100 is covered with the separator 30. However, the insulation between the positive electrode 10 and the cell case 210 may be achieved via another insulating member. In this case, the positive electrode material layer 12 may be exposed at the outermost layer of the electrode body 100.

A detailed description will be given below of each component of the electrochemical device.

### (Positive Electrode Core Material)

For the positive electrode core material, a sheet of metal material is used. The sheet of metal material may be a metal foil, a metal porous body, an etched metal, and the like. Examples of the metal material include aluminum, an aluminum alloy, nickel, and titanium. The thickness of the positive electrode core material is, for example, 10 to 100 μm. The positive electrode core material may have a carbon layer. Being interposed between the positive electrode core material and the positive electrode material layer, the carbon layer functions to improve the performance of current collecting from the positive electrode material layer to the positive electrode core material.

### (Carbon Layer)

The carbon layer is formed, for example, by vapor-depositing a conductive carbon material on a surface of the positive electrode core material, or applying a carbon paste containing a conductive carbon material on a surface of the positive electrode core material, and drying the applied film. The carbon paste includes, for example, a conductive carbon material, a polymer material, and water or an organic solvent. The thickness of the carbon layer may be, for example, 1 to 20 μm. Examples of the conductive carbon material include graphite, hard carbon, soft carbon, and carbon black. In particular, carbon black can form a thin carbon layer having excellent conductivity. Examples of the polymer material include a fluorocarbon resin, an acrylic resin, polyvinyl chloride, and styrene-butadiene rubber (SBR).

### (Positive Electrode Material Layer)

The positive electrode material layer contains a conductive polymer. The positive electrode material layer is formed, for example, by immersing a positive electrode core material provided with a carbon layer, in a reaction liquid containing a raw material monomer of a conductive polymer, and subjecting the raw material monomer to electrolytic polymerization in the presence of the positive electrode core material. At this time, by performing electrolytic polymerization using the positive electrode core material as an anode, a positive electrode material layer containing a conductive polymer can be formed so as to cover the carbon layer. The thickness of the positive electrode material layer can be controlled by the electrolytic current density, the time for polymerization, and the like. The thickness of the positive electrode material layer is, for example, 10 to 300 μm per one side.

The conductive polymer used here can easily accept protons in a strongly acidic environment. The conductive polymer preferably has a functional group with proton equilibrium. Examples of the functional group with proton equilibrium include an imino group (—NH—, ═NH), —N═, an amino group (—NH₂), an amide group, a carboxylate group (COO), and a phenolate group. The acid dissociation constant pKa of the conductive polymer in water as a solvent may be in the range of 2.5 to 7. A functional group with proton equilibrium may be added to the conductive polymer so that the pKa is in the above range.

Preferred as the conductive polymer is a π-conjugated polymer. The π-conjugated polymer may be, for example, polyaniline or a derivative of polyaniline. The polyaniline may be mixed with polypyrrole, polythiophene, polyfuran, polythiophene vinylene, polypyridine, or a derivative thereof. The weight-average molecular weight of the conductive polymer is, for example, 1,000 to 100,000. A derivative of a π-conjugated polymer refers to a polymer having a π-conjugated polymer, such as polypyrrole, polythiophene, polyfuran, polyaniline, polythiophene vinylene, and polypyridine, as its basic skeleton. For example, the derivative of polythiophene includes poly(3,4-ethylenedioxythiophene) (PEDOT).

A derivative of polypyrrole, polythiophene, polyfuran, polythiophene vinylene, or polypyridine may be used singly as the conductive polymer, as long as the pKa of the derivative is adjusted in the range of 2.5 to 7.

The positive electrode material layer may be formed by a method other than electrolytic polymerization. For example, chemical polymerization of a raw material monomer may be employed to form a positive electrode material layer containing a conductive polymer. Also, a pre-synthesized conductive polymer or a dispersion thereof may be used to form a positive electrode material layer.

The raw material monomer used for electrolytic polymerization or chemical polymerization may be a polymerizable compound capable of producing a conductive polymer through polymerization. The raw material monomer may include an oligomer. For example, the raw material monomer may be aniline or an aniline derivative. The aniline may be added with pyrrole, thiophene, furan, thiophene vinylene, pyridine or a derivative thereof. Aniline can be easily grown through electrolytic polymerization on the carbon layer.

The electrolytic polymerization or chemical polymerization can be allowed to proceed using a reaction solution containing an anion (dopant). By doping the n-electron conjugated polymer with a dopant, excellent conductivity can be developed. The doping can be done by, for example, in the chemical polymerization, immersing a positive electrode core material in a reaction liquid containing a dopant, an oxidizing agent, and a raw material monomer, and then, taking out from the reaction solution, followed by drying. In the electrolytic polymerization, it can be done by, for example, immersing a positive electrode core material together with a counter electrode in a reaction liquid containing a dopant and a raw material monomer, and applying a current therebetween, with the positive electrode core material used as an anode.

The solvent of the reaction liquid may be water, but in view of the solubility of the monomer, may be a non-aqueous solvent. The non-aqueous solvent is desirably alcohols, such as ethyl alcohol, methyl alcohol, isopropyl alcohol, ethylene glycol and propylene glycol, and the like. The dispersion medium or solvent of the conductive polymer also may be water or the aforementioned non-aqueous solvent.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆), a fluorosulfate ion (F₅O₃⁻), a bis(fluorosulfonyl)imide ion (N(FSO₂)₂), and a bis(trifluoromethanesulfonyl)imide ion (N(CF₃SO₂)₂). These may be used singly or in combination of two or more kinds.

The dopant may be a polymer ion. Examples of the polymer ion include ions of polyvinyl sulfonic acid, polystyrene sulfonic acid, polyallyl sulfonic acid, polyacrylic sulfonic acid, polymethacrylic sulfonic acid, poly(2-acrylamido-2-methylpropanesulfonic acid), polyisoprene sulfonic acid, and polyacrylic acid. These may be a homopolymer or a copolymer of two or more kinds of monomers. These may be used singly or in combination of two or more kinds.

### (Positive Electrode Current Collector Plate)

The positive electrode current collector plate is an approximately disc-like metal plate. The positive electrode current collector plate is preferably provided at its center with a through-hole serving as a flow path of non-aqueous electrolyte. The material of the positive electrode current collector plate is, for example, aluminum, an aluminum alloy, titanium, stainless steel, and the like. The material of the positive electrode current collector plate may be the same as that of the positive electrode core material.

### (Negative Electrode Core Material)

For the negative electrode core material, too, a sheet of metal material is used. The sheet of metal material may be a metal foil, a metal porous body, an etched metal or the like. Examples of the metal material include copper, a copper alloy, nickel, and stainless steel. The thickness of the negative electrode core material is smaller than that of the positive electrode core material, and is, for example, 10 to 100 μm.

The negative electrode material layer preferably contains, as a negative electrode active material, a material that electrochemically absorbs and releases lithium ions. Such a material is exemplified by a carbon material, a metal compound, an alloy, a ceramic material, and the like. Preferred examples of the carbon material include graphite, non-graphitizable carbon (hard carbon), and graphitizable carbon (soft carbon), among which graphite and hard carbon are particularly preferred. Examples of the metal compound include a silicon oxide and a tin oxide. Examples of the alloy include a silicon alloy and a tin alloy. Examples of the ceramic material include lithium titanate and lithium manganate. These may be used singly or in combination of two or more kinds. In particular, a carbon material is preferable in that it can lower the potential of the negative electrode.

The negative electrode material layer may contain, in addition to the negative electrode active material, a conductive agent, a binder, and the like. Examples of the conductive agent include carbon black and carbon fiber. Examples of the binder include a fluorocarbon resin, an acrylic resin, a rubber material, and a cellulose derivative.

The negative electrode material layer is formed, for example, by mixing a negative electrode active material, a conductive agent and a binder, together with a dispersion medium, to prepare a negative electrode material mixture paste, and applying the negative electrode material mixture paste onto a negative electrode current collector, followed by drying. The thickness of the negative electrode material layer is, for example, 10 to 300 μm per one side.

The negative electrode material layer may be pre-doped with lithium ions in advance. This lowers the potential of the negative electrode. Therefore, the potential difference between the positive and negative electrodes (i.e., the voltage) is increased, leading to an improved energy density of the electrochemical device. The pre-doping of lithium ions into the negative electrode material layer can be proceeded by, for example, applying metal lithium, in a film form, onto a surface of the negative electrode material layer, and then, impregnating the negative electrode with a non-aqueous electrolyte. Lithium ions leach out from the metal lithium into the non-aqueous electrolyte and are absorbed into the negative electrode material layer. For example, when the negative electrode active material is graphite or hard carbon, lithium ions are inserted between the layers of graphite or into the pores of hard carbon. The amount of lithium to be pre-doped is, for example, about 50% to 95% of the maximum amount that can be absorbed into the negative electrode material layer.

The pre-doping of lithium ions into the negative electrode material layer may be performed before forming an electrode body. The pre-doping may be allowed to proceed after the electrode body is housed together with a non-aqueous electrolyte in a battery case.

### (Negative Electrode Current Collector Plate)

The negative electrode current collector plate is an approximately disc-like metal plate. The material of the negative electrode current collector plate is, for example, copper, a copper alloy, nickel, stainless steel, and the like. The material of the positive electrode current collector plate may be the same as that of the negative electrode core material.

### (Separator)

For the separator, a non-woven fabric made of cellulose fibers, a non-woven fabric made of glass fibers, a microporous film or a woven or non-woven fabric made of polyolefin, and like can be used. In particular, a cellulose-based separator may be used in terms of its inexpensiveness. In the electrochemical device of the present embodiment, since the electrolyte hardly becomes strongly acidic, the deterioration in characteristics of the separator can be suppressed. The thickness of the separator is, for example, 10 to 300 μm, and preferably 10 to 40 μm.

### (Electrolyte)

The electrolyte has lithium ion conductivity and contains a lithium salt and a solvent that dissolves the lithium salt. The anion of the lithium salt can be reversibly and repeatedly doped into and de-doped from the positive electrode. On the other hand, lithium ions derived from the lithium salt are reversibly absorbed into and released from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. These may be used singly or in combination of two or more kinds. In particular, a salt having a fluorine-containing anion is preferred. The concentration of the lithium salt in the non-aqueous electrolyte in a charged state (State of charge (SOC): 90 to 100%) is, for example, 0.2 to 5 mol/L.

The solvent may be a non-aqueous solvent. Examples of the non-aqueous solvent include: cyclic carbonates, such as ethylene carbonate, propylene carbonate, and butylene carbonate; chain carbonates, such as dimethyl carbonate, diethyl carbonate, and ethyl methyl carbonate; aliphatic carboxylic acid esters, such as methyl formate, methyl acetate, methyl propionate, and ethyl propionate; lactones, such as γ-butyrolactone (GBL), and γ-valerolactone; chain ethers, such as 1,2-dimethoxyethane (DME), 1,2-diethoxyethane (DEE), and ethoxymethoxyethane (EME); cyclic ethers, such as tetrahydrofuran and 2-methyltetrahydrofuran; and others, such as dimethyl sulfoxide, 1,3-dioxolane, formamide, acetamide, dimethylformamide, dioxolane, acetonitrile, propionitrile, nitromethane, ethyl monoglyme, trimethoxymethane, sulfolane, methylsulfolane, and 1,3-propane sultone. These may be used singly or in combination of two or more kinds.

Various additives may be added, if necessary, to the electrolyte. For example, as an additive for forming a surface layer with lithium ion conductivity on a surface of the negative electrode, an unsaturated carbonate, such as vinylene carbonate, vinyl ethylene carbonate, and divinyl ethylene carbonate, may be added.

### EXAMPLES

The present invention will be more specifically described below with reference to Examples. The present invention is, however, not limited to the Examples.

### Example 1

### (1) Production of Positive Electrode

An aluminum foil (positive electrode core material) having a thickness of 25 μm was prepared. The positive electrode core material and a counter electrode were immersed in an aqueous aniline solution containing aniline and sulfuric acid, and electrolytic polymerization was allowed to proceed at a current density of 10 mA/cm² for 20 min, thereby to grow a film of conductive polymer (polyaniline) doped with sulfate ions (SO₄²⁻) as a positive electrode material layer on the positive electrode core material. At this time, a positive electrode core material exposed portion having a width of 10 mm was formed at an end portion along the longitudinal direction of the positive electrode core material. Next, the polymer doped with sulfate ions was reduced, to de-dope the sulfate ions that have been doped, and then dried. The thickness of the positive electrode material layer was set to 50 μm per one side. The width We of the positive electrode material layer was set to 60 mm.

### (2) Production of Negative Electrode

A copper foil (negative electrode core material) having a thickness of 10 μm was prepared. Separately, a negative electrode material mixture paste was prepared by kneading a mixed powder of 97 parts by mass of hard carbon, 1 part by mass of carboxy cellulose, and 2 parts by mass of styrene-butadiene rubber, with water at a mass ratio of 40:60. The negative electrode material mixture paste was applied onto both sides of the negative electrode core material and dried, to form a negative electrode material layer having a thickness of 50 μm. A negative electrode core material exposed portion having a width of 10 mm was formed at an end portion along the longitudinal direction of the negative electrode core material. The width W_{A} of the negative electrode material layer was set to 58 mm.

Next, a thin film of metal lithium was formed by vacuum vapor deposition, on the entire surface of the negative electrode material layer. The amount of lithium to be pre-doped was set such that the negative electrode potential in the non-aqueous electrolyte upon completion of pre-doping became 0.1 V or less versus metal lithium.

### (3) Formation of Electrode Body

The positive electrode and the negative electrode were wound in a columnar shape, with a separator (thickness: 35 μm) of a cellulose nonwoven fabric interposed therebetween, to form an electrode body. At this time, a stack of the positive electrode, the negative electrode, and the separator was wound, such that the positive electrode came on the radially inner side, and the negative electrode came on the radially outer side. The outermost layer of winding was the separator, and on its radially inner side, the positive electrode was facing the separator being the outermost layer. The positive electrode core material exposed portion was protruded from one end surface of the wound body, and the negative electrode core material exposed portion was protruded from the other end surface of the electrode body. A positive electrode current collector plate and a negative electrode current collector plate each in a disc-like shape were welded to the positive electrode core material exposed portion and the negative electrode core material exposed portion, respectively.

### (4) Preparation of Non-Aqueous Electrolyte

A solvent was prepared by adding 0.2 mass % of vinylene carbonate to a mixture of 1:1 volume ratio of propylene carbonate and dimethyl carbonate. To the solvent, LiPF₆ was dissolved as a lithium salt at a predetermined concentration, to prepare a non-aqueous electrolyte having a hexafluorophosphate ion (PF₆⁻) as an anion.

### (5) Fabrication of Electrochemical Device

The wound body was housed in a bottomed cell case having an opening. A tab lead connected to the positive electrode current collector plate was connected to the inner surface of a sealing plate, and a negative electrode current collector plate was welded to the inner bottom surface of the cell case. After the non-aqueous electrolyte was injected into the cell case, the opening of the cell case was sealed with the sealing plate. An electrochemical device as illustrated in FIG. 1 was thus fabricated. Thereafter, with a charge voltage of 3.8 V being applied between the positive and negative electrode terminals, aging was performed at 25° C. for 24 hours, to complete the pre-doping of lithium ions into the negative electrode.

In this way, an electrochemical device A1 was produced. The electrochemical device A1 had a positive electrode non-facing portion at the positive electrode outermost layer portion and at the positive electrode innermost circumferential portion, and the positive electrode non-facing portion was larger in area than the negative electrode non-facing portion.

### Comparative Example 1

In the formation of the electrode body, the stack of the positive electrode, the negative electrode, and the separator was wound, such that the positive electrode came on the radially outer side, and the negative electrode came on the radially inner side. The outermost layer of winding was the separator, and on its radially inner side, the negative electrode was facing the separator being the outermost layer.

An electrochemical device B1 was produced in the same manner as in Example 1, except the above. The electrochemical device B1 had a negative electrode non-facing portion at the negative electrode outermost layer, and, at a portion located on the innermost layer side of winding in the negative electrode (i.e., negative electrode innermost layer portion). The positive electrode non-facing portion was smaller in area than the negative electrode non-facing portion.

### (Evaluation)

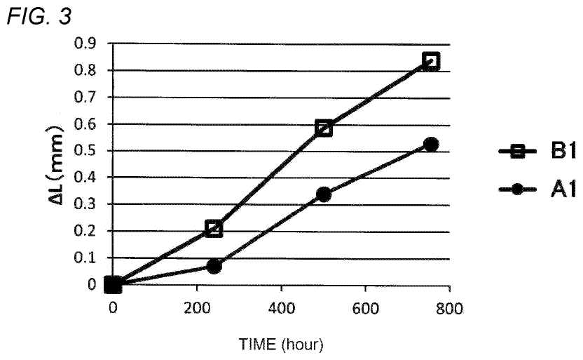

To the electrochemical devices A1 and B1, in a 60° C. thermostatic oven, a voltage of 3.6 V was applied between the positive and negative electrode terminals for 750 hours. Every after 250 hours, the maximum height ΔL of the outer bottom surface of the cell case relative to the boundary position between the bottom portion and the cylindrical portion of the cell case was measured with a caliper. The change with time of ΔL is shown in FIG. 3.

As shown in FIG. 3, the swelling of the cell case was suppressed in the electrochemical device A1, as compared to in the electrochemical device B1. After 750 hours, the electrochemical device B1 had a swelling of 0.84 mm, but in contrast, the electrochemical device A1 had a swelling of 0.53 mm. This shows that in the electrochemical device A1 in which the positive electrode non-facing portion was larger in area than the negative electrode non-facing portion, the swelling was small, and the gas generation was suppressed, as compared to in the electrochemical device B1 in which the positive electrode non-facing portion was smaller in area than the negative electrode non-facing portion.

### INDUSTRIAL APPLICABILITY

The electrochemical device according to the present disclosure is suitably applicable for, for example, vehicle use.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

100: electrode body
   10: positive electrode
   11: positive electrode core material
      11x: positive electrode core material exposed portion
   12: positive electrode material layer
   13: positive electrode current collector
   15: tab lead
   20: negative electrode
   21: negative electrode core material
      21x: negative electrode core material exposed portion
   22: negative electrode material layer
   23: negative electrode current collector
   30: separator
   200: electrochemical device
   210: cell case
   220: sealing plate
   221: gasket

1. An electrochemical device, comprising:
a positive electrode including a positive electrode core material, and a positive electrode material layer supported on the positive electrode core material;
a negative electrode including a negative electrode core material, and a negative electrode material layer supported on the negative electrode core material;
a separator placed between the positive electrode and the negative electrode; and
an electrolyte containing lithium ions, wherein
the positive electrode material layer contains a conductive polymer,
the positive electrode has a positive electrode non-facing portion where the positive electrode material layer does not face the negative electrode material layer, the positive electrode non-facing portion being larger in area than a negative electrode non-facing portion where the negative electrode material layer does not face the positive electrode material layer in the negative electrode.

2. The electrochemical device according to claim 1, wherein
a stack of the positive electrode, the negative electrode, and the separator interposing between the positive electrode and the negative electrode is wound into an electrode body, and
an area of the positive electrode non-facing portion on an outermost layer side of winding in the positive electrode is larger than an area of the negative electrode non-facing portion on an outermost layer side of winding in the negative electrode.

3. The electrochemical device according to claim 1, wherein an innermost layer of winding is the positive electrode.

4. The electrochemical device according to claim 1, wherein an acid dissociation constant pKa of the conductive polymer in water as a solvent is 2.5 to 7.

5. The electrochemical device according to claim 1, wherein the conductive polymer includes polyaniline.

6. The electrochemical device according to claim 1, wherein the separator includes a cellulose material.
